(19) United States
(12) Patent Application Publication
(10) Pub. No.: US 2025/0198735 A1
(43) Pub. Date: Jun. 19, 2025

(54) METHOD FOR LOCATING A MARK ON A TURBOMACHINE CASING

(71) Applicant: SAFRAN AIRCRAFT ENGINES, Paris (FR)

(72) Inventors: Thomas Laurent Frederic GAUDUCHON, Moissy-Cramayel (FR); Remy Olivier PARGNY, Moissy-Cramayel (FR); Nicolas Daniel DELAPORTE, Moissy-Cramayel (FR)

(21) Appl. No.: 18/845,740

(22) PCT Filed: Mar. 16, 2023
(86) PCT No.: PCT/FR2023/050373

§ 371 Date: Sep. 10, 2024

(30) Foreign Application Priority Data
Mar. 18, 2022 (FR) 2202422

(51) Int. Cl. G01B 5/14; F01D 25/24

(52) U.S. Cl. CPC G01B 5/14; F01D 25/24

(57) ABSTRACT

A method for locating a mark on a casing of a turbomachine of an aircraft, wherein the method includes a) a step of visually inspecting the arms, the outer surface of the internal shroud and the inner surface of the external shroud, and, in the event that at least one mark is detected at step a), b) a step of manually mounting a visual inspection device around the inner end or outer end of one or more of the arms, and c) a step of determining the location of the at least one mark in a zone of the casing.

### TECHNICAL FIELD OF THE INVENTION

This invention relates to a method for locating a mark on the casing of a turbomachine, in particular an aircraft, and to a tooling for implementing this method.

### TECHNICAL BACKGROUND

The technical background comprises in particular the documents US-A1-2004/147893, EP-A1-1 582 838 and EP-A1-3 067 140.

Classically, a turbomachine comprises, from upstream to downstream with reference to the flow of gases in this turbomachine, a fan, one or more compressors, an annular combustion chamber and one or more turbines.

A turbomachine comprises a number of casings which are stationary elements, i.e., stator elements, as opposed to rotor elements which are movable in rotation.

A turbomachine casing is generally annular in shape around an axis that coincides with the longitudinal axis of the turbomachine. This longitudinal axis is generally the axis of rotation of the rotors of the turbomachine and the axis along which the gases flow inside the turbomachine.

In the present application, the casing is a casing essentially comprising two coaxial annular shrouds, internal shroud and external shroud respectively, and arms which extend between the shrouds and connect them together.

This type of casing may be located between two compressors of the turbomachine and is then referred to as an intermediate casing. This type of casing may also be located downstream of the turbines of the turbomachine and is referred to as an exhaust casing.

The two shrouds define a portion of the gas flow vein between them. The arms that extend between the shrouds pass through the vein and divide it into several parts. These arms may have different shapes and some may be hollow, and comprise internal cavities that open towards the inside of the internal shroud and towards the outside of the external shroud. These hollow arms allow the passage of auxiliaries such as cables and ducts to pass through the casing from the outside to the inside or vice versa.

When this type of casing is produced and before it is mounted to a turbomachine, it is important to check its condition. It is also important to check the condition of this type of casing during maintenance operations on the turbomachine, when it is dismantled or when it is still hanging under the wing of an aircraft, for example.

The state of the casing is checked during a control operation which comprises a step to locate any marks on the casing.

In the present application, “mark” means an element on the casing that is not deliberate and that is visible, i.e., that may be spotted with the naked eye by an operator. A mark is, for example, wear, a scratch, an impact, a defect, etc. A mark may be, for example, 1 to 2 mm long and less than 1 mm deep.

During the control operation, the operator checks the casing for marks. If a mark is detected, it must be listed and, in particular, located so that it may be analyzed later. The following analysis is necessary to determine whether the mark is minor and of no consequence, whether the mark is significant and requires a special maintenance of the casing, or whether the mark is too large and requires the casing to be scrapped and replaced.

If, for example, the mark is an impact that forms a depression in the casing, the next maintenance step would be to repair the casing by, for example, webbing, adding material to the depression, grinding by machining, and so on.

During this operation, the location of the mark is of fundamental importance, as a mark located near the junction of an arm with one of the shrouds, for example, is not treated in the same way as an identical mark located on one of the shrouds and at a distance from the nearest arms.

The marks near the junction between the arms and the shrouds may have a direct impact on the mechanical strength and therefore the service life of the casing. It is therefore important during this operation to locate the marks on the casing as precisely as possible so that they may be analyzed accordingly.

With the current technology, locating a mark on the casing is done by hand using a ruler or similar. After visually spotting a mark, the operator uses a ruler to locate it, for example by measuring its distance from a junction between an arm and one of the shrouds.

This procedure is time-consuming and imprecise, not least because of the complex shape of the arms. The same mark may not be located in exactly the same place by two different operators, or by the same operator taking two successive measurements. It is not possible to achieve good repeatability of measurements with current technology. This may lead to misinterpretation.

There is therefore a need to identify a solution to this problem that will the localization of the mark more reliable, increase the repeatability of this type of localization and also reduce its duration.

### SUMMARY OF THE INVENTION

The invention relates to a method for locating a mark on the casing of an aircraft turbomachine, this casing comprising two coaxial annular shrouds, an internal shroud and an external shroud respectively, and arms which extend between the shrouds and which each comprise an inner end connected to an outer annular surface of the internal shroud and an outer end connected to an inner annular surface of the external shroud, characterized in that it comprises:
a) a step of visually inspecting the arms, the outer annular surface of the internal shroud, and the inner annular surface of the external shroud, and if at least one mark is detected in step a),
b) a step of manually mounting a visual control device around the inner or outer end of one or more of the arms on which said at least one mark is detected, the or each control device being configured to cover part of the inner end of an arm and part of the outer annular surface of the internal shroud extending around that inner end, or to cover part of the outer end of the arm and part of the inner annular surface of the external shroud extending around that outer end, and
c) a step of determining the location of said at least one mark in an area of the casing:
   said at least one mark being located in a first area of the casing, which is an area of junction of one of the arms with one of the shrouds, when said at least one mark is hidden by the control device in step b),
   said at least one mark being located in a second area of the casing, which is an area of an arm excluded from the junction areas of this arm, when said at least one mark is located on the annular surface of the shroud and is not hidden by the control device in step b), and
   said at least one mark being located in a third area of the casing, which is an area of the casing excluded from the junction areas of the arms, when said at least one mark is located on the arm and is not hidden by the control device in step b).

The invention makes it easier and more reliable to locate marks on a turbomachine casing by using one or more control devices. The or each control device is mounted at one end of an arm, i.e., its inner end on the internal shroud side or its outer end on the external shroud side. Each control device is preferably shaped and dimensioned to best match the shape of the arm at the level of that end. The shape and dimensions of the device are also advantageously predetermined so that the control device covers the most sensitive and fragile areas of the casing, i.e., the areas located at the junctions between the arms and the shrouds. These areas are referred to as first areas. The other areas of the casing are less sensitive and are less affected by the presence of marks. These other areas are second areas located on the shrouds at a distance from the aforementioned junctions, and third areas located on the arms at a distance from the junctions.

This means that the or each mark may be easily and quickly located in one of these areas. If a mark disappears because it is hidden by the control device when it is mounted on the arm, then this mark is located in the first area of this arm. If a mark is not hidden by the control device and is located on the shroud, then this mark is located in a second area next to this arm. If a mark is not hidden by the control device and is located on the arm, then this mark is located in the third area of this arm.

If a mark is located in the first area of an arm, then the method according to the invention could be followed by a maintenance method wherein the casing is repaired to remove or attenuate the mark, for example.

The method according to the invention may comprise one or more of the following characteristics or steps, taken in isolation from one another, or in combination with one another:
the method comprises, between steps b) and c):
i) a first intermediate step wherein at least one line is drawn on the arm and/or the outer annular surface of the internal shroud and/or the inner annular surface of the external shroud, along edges of the or each control device, and
ii) a second intermediate step wherein the or each control device is removed from the casing,
and wherein step c) is carried out as a function of the position of said at least one mark relative to the or each line drawn; it is therefore understood that the location of the or each mark in one of the aforementioned areas may be determined after the control device has been removed, by means of the line or lines drawn on the casing which allow to delimit these areas;
   said at least one line is drawn with a felt-tip pen;
   in step b): a first control device is mounted around an inner end of a first arm on which said at least one mark is detected, and a second control device is mounted around an inner end of an adjacent second arm on which said at least one mark (46, 48) is detected;
   in step b): a third control device is mounted around an outer end of the first arm on which said at least one mark (46, 48) is detected, and a fourth control device is mounted around an outer end of the adjacent second arm on which said at least one mark (46, 48) is detected;
   the or each control device comprising two blocks, step b) comprises positioning the two blocks on either side of the arm;
   the two blocks are attached or held together, for example by magnets that may be integrated into the blocks or by attachment members; alternatively, the two blocks could simply be held together manually;
   each of the blocks is formed in one-part;
   each of the blocks is produced by additive manufacturing.

The present invention also relates to a tooling for carrying out a method as described above, the tooling comprising at least one visual control device configured to be mounted around an outer or inner end of an arm of the casing, the or each control device comprising two blocks configured to be mounted on either side of the arm, each of these blocks comprising:
a first part configured to cover part of the inner annular surface of the external shroud or the outer annular surface of the internal shroud,
a second part configured to cover part of a pressure side or suction side face of the arm, and
a junction between the first and second parts configured to extend at the level of a connection fillet connecting the face part with the annular surface part.

The tooling according to the invention may comprise one or more of the following characteristics, taken alone or in combination with each other:
each of the blocks is generally L-shaped;
each of the blocks comprises projecting pads configured to bear on the casing, the remainder of each of the blocks being configured to be set back relative to the casing to define a mounting clearance for the or each control device; this mounting clearance allows to compensate for any variations in the dimensions of the casing as a result of manufacturing tolerances;
each of the blocks comprises a longitudinal edge configured to form a tracing reference;
each of the blocks comprises at least one portion configured to be applied against a complementary portion of the other of the blocks, so as to allow the two blocks to be attached or held relative to each other;
the two blocks of the same device have an identical colour which is different from the colour of the blocks of the other device, or from the colours of the blocks of the other devices;
each of the blocks comprises a mounting indication on the inner or outer end of the arm; this indication may be integrated into each block and may, for example, be a projecting or recessed wording, such as “out” and “in”, referring to mounting on the outer end or the inner end of the arm;
the tooling comprises at least two independent control devices configured to be mounted around the inner ends of the arms, and two further independent control devices configured to be mounted around outer ends of the arms; in the event that the casing to be inspected has two types of arm, the tooling could then comprise only those four control devices which would be used to be mounted on the ends of the different arms;
the control devices are all different;
each of the blocks is formed in one-part;
each of the blocks is produced by additive manufacturing.

### BRIEF DESCRIPTION OF THE FIGURES

Further characteristics and advantages will be apparent from the following description of a non-limiting embodiment of the invention with reference to the appended drawings wherein:

FIG. 1 is a partial schematic view of an aircraft turbomachine in axial section,

FIG. 2 is a perspective view of a casing for an aircraft turbomachine, such as that shown in FIG. 1,

FIG. 3 is a larger scale view of part of FIG. 2 and shows the junction between an inner end of an arm and the internal shroud of the casing,

FIG. 4 is a perspective view of a tooling for implementing a method according to the invention for locating a mark on a turbomachine casing, this tooling comprising several independent control devices,

FIG. 5 is a partial schematic perspective view of a casing on which two control devices are mounted at the level of the outer ends of two adjacent arms, the control devices being different depending on the shape and size of the arms,

FIG. 6 is a partial schematic perspective view of a casing on which two control devices are mounted at the level of the inner ends of two adjacent arms, these control devices may be different depending on the shape and size of the arms,

FIG. 7a is a schematic perspective view of a junction between an arm and a shroud and shows the mounting of a control device at the level of this junction, during a method according to the invention;

FIG. 7b is a schematic perspective view of a junction between an arm and a shroud and shows the mounting of a control device at the level of this junction, during a method according to the invention;

FIG. 7c is a schematic perspective view of a junction between an arm and a shroud and shows the mounting of a control device at the level of this junction, during a method according to the invention;

FIG. 8 is a schematic cross-sectional perspective view of a control device mounted on the junction of an arm; and

FIG. 9 is a schematic perspective view of a junction between an arm and a shroud and shows the drawing of lines on the casing and the location of marks on the casing during a method according to the invention.

### DETAILED DESCRIPTION OF THE INVENTION

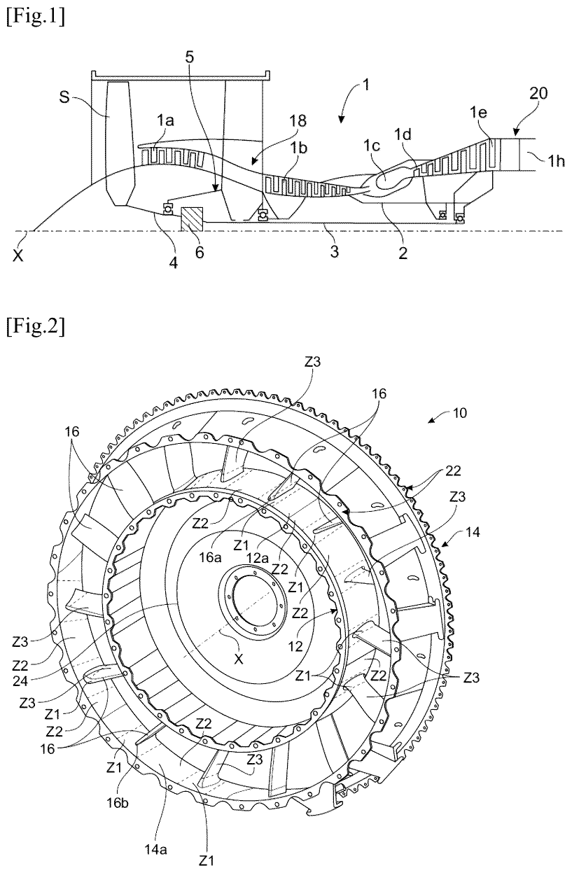

FIG. 1 describes a turbomachine 1 which conventionally comprises an axis of rotation X, a fan S, a low-pressure compressor 1a, a high-pressure compressor 1b, an annular combustion chamber 1c, a high-pressure turbine 1d, a low-pressure turbine 1e and an exhaust nozzle 1h. The high-pressure compressor 1b and the high-pressure turbine 1d are connected by a high-pressure shaft 2 and together they form a high-pressure (HP) body. The low-pressure compressor 1a and the low-pressure turbine 1e are connected by a low-pressure shaft 3 and together they form a low-pressure (LP) body.

The fan S is driven by a fan shaft 4 which may be connected to the LP shaft 3 by means of a reducer 6. This reducer 6 is generally of the planetary or epicyclic type.

The turbomachine 1 comprises several casings which are stator elements. An example of a casing 10 is shown in FIG. 2. This type of casing comprises two coaxial annular shrouds, an internal shroud 12 and an external shroud 14, and arms 16 which extend between the shrouds 12, 14 and connect them together.

The shrouds 12, 14 define between them a portion of the gas flow vein in the turbomachine 1. When the casing 10 is fitted between the LP compressor 1a and the HP compressor 1b, this casing 10 is referred to as an intermediate casing and is referenced 18 in FIG. 1. The shrouds 12, 14 then define between them the portion of vein extending between the compressors LP 1a and HP 1b. When the casing 10 is mounted downstream of the LP turbine 1e, this casing 10 is referred to as the exhaust casing and is referenced 20 in FIG. 1. The shrouds 12, 14 then define between them the portion of the vein at the outlet of the LP turbine 1e.

At their upstream and downstream ends, the shrouds 12, 14 may typically comprise annular flanges 22 for attachment to complementary annular flanges on other casings of the turbomachine 1 (FIG. 2). The internal shroud 12 may be connected to a bulkhead 24 in the casing 10.

The arms 16 divide the vein located between the shrouds 12, 14 into several sectors. The arms 16 may have a radial orientation with respect to the axis X or be inclined with respect to radii to the axis X.

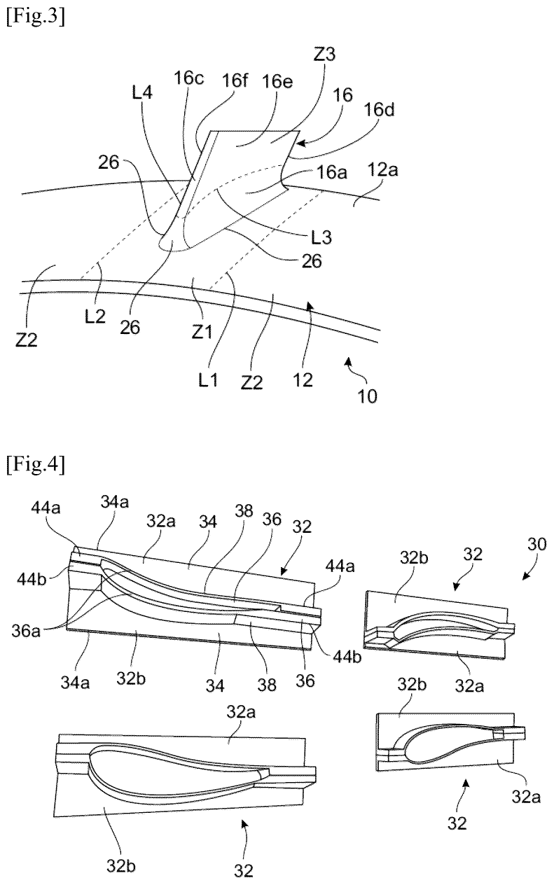

The arms 16 each comprise an inner end 16a connected to an outer annular surface 12a of the internal shroud 12 (FIGS. 2 and 3), and an outer end 16b connected to an inner annular surface 14a of the external shroud 14 (FIG. 2).

Each of the arms 16 has an aerodynamic profile and comprises a leading edge 16c (upstream), a trailing edge 16d (downstream) and two lateral faces 16e, 16f extending between the leading edge 16c and the trailing edge 16d (FIG. 3). One of the faces 16e may have a concave curved shape and form a pressure side face, and the other of the faces 16f may have a convex curved shape and form a suction side face (FIG. 3).

The surfaces of the casing 10 located in the vein are separated into three areas:
the first areas Z1 are the areas where the arms 16 are joined to the shrouds 12, 14 and therefore the connection areas and therefore the connection fillets 26 for connecting the ends 16a, 16b of the arms to the surfaces 12a, 14a of the shrouds 12, 14; FIG. 3 shows one of these areas Z1 which extends here around an inner end 16a of an arm 16;
the second areas Z2 are the areas of the surfaces 12a, 14a of the shrouds 12, 14 situated between the areas Z1 and therefore at a distance from the junctions of the arms 16; FIG. 2 shows these areas Z2; and
the third areas Z3 are the areas of the arms 16 and in particular their faces 16e, 16f located between the areas Z1 and therefore at a distance from the junctions of the arms 16; FIG. 2 shows these areas Z3.

In FIG. 3, the area Z1 is separated from an area Z2, located on the side of the pressure side face 16e of the arm 16, by an imaginary line L1 which is located on the surface 12a, 14a and which extends substantially parallel to a chord of the arm 16 or to the axis X of the casing 10. The area Z1 is separated from another area Z2, located on the side of the suction side face 16f of the arm 16, by an imaginary line L2 which is located on the surface 12a, 14a and which extends substantially parallel to the chord of the arm 16 or to the axis X of the casing 10. The area Z1 is also separated from the area Z3, located on the faces 16e, 16f of the arm 16, by imaginary lines L3, L4 located respectively on the pressure side 16e and suction side 16f faces of the arm 16.

The present invention provides a method for locating a mark on a turbomachine casing such as that described above, as well as a tooling for implementing this method.

FIG. 4 shows an example of embodiment of a tooling 30 for implementing the method. This tooling 30 comprises one or more visual inspection devices 32—of which there are four in the example shown.

Each device 32 is configured to be mounted around an outer end 16b or inner end 16a of an arm 16 of the casing 10 to cover an area Z1.

Each control device 32 preferably comprises two blocks 32a, 32b configured to be mounted on either side of the arm 16. One of the blocks 32a is configured to be mounted on the side of the pressure side face 16e of the arm 16 and the other of the blocks is configured to be mounted on the side of the suction side face 16f of the arm 16. Each of the blocks 32a, 32b has a generally elongate shape and is configured to extend from the leading edge 16c to the trailing edge 16d of the arm in the mounted position on the arm 16.

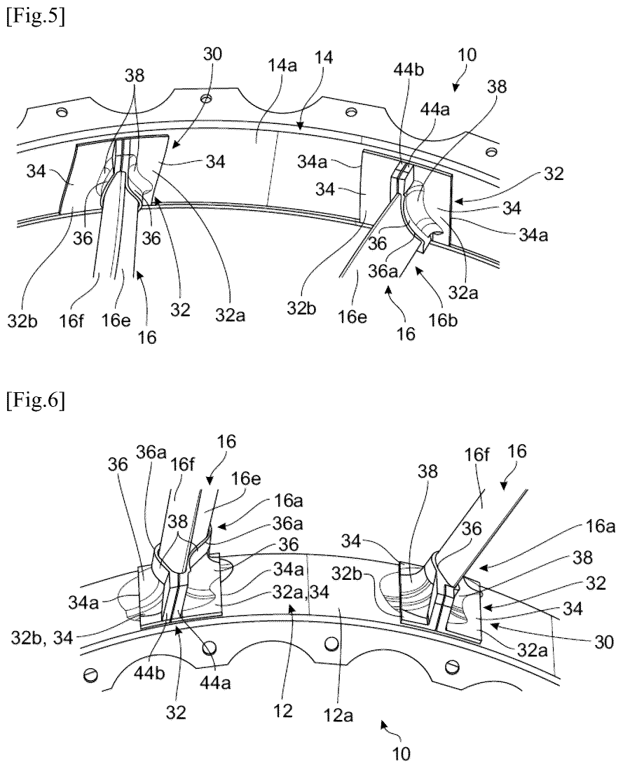

More particularly, as may be seen in FIGS. 5 and 6, each of these blocks 32a, 32b comprises:
a first part 34 configured to cover part of the inner surface 14a of the external shroud 14 or the outer surface 12a of the internal shroud 12,
a second part 36 configured to cover part of the pressure side face 16e or suction side face 16f of the arm 16, and
a junction 38 between the first and second parts 34, 36 configured to extend at the level of the connection fillet 26 connecting the face part 16e, 16f with the surface part 12a, 14a.

The first part 34 of each block 32a, 32b is formed by a relatively flat wall in the example shown, insofar as it extends over the surface 12a, 14a of the shroud 12, 14.

The first part 34 of each block 32a, 32b comprises a free longitudinal edge 34a which is configured to extend along the aforementioned line L1 or L2. Each edge 34a is a tracing edge.

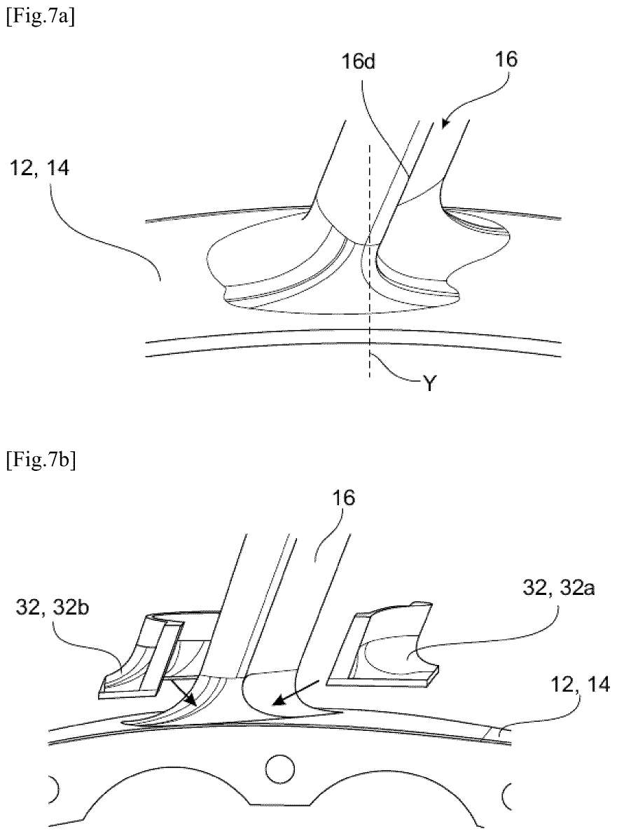

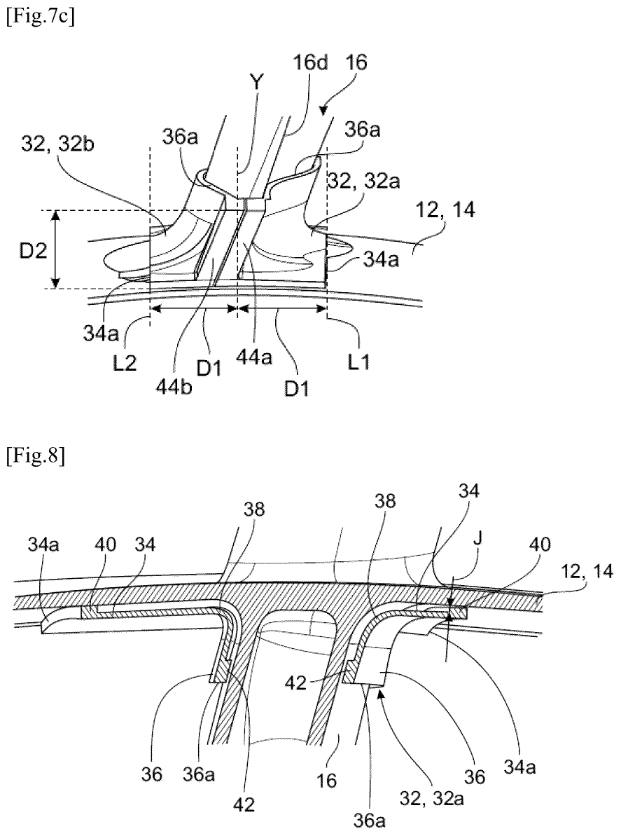

FIG. 7a shows an axis Y passing through the end of the trailing edge 16d connected to the shroud 12, 14, this axis Y being substantially perpendicular to the shroud at the point where the trailing edge 16d connects to this shroud. The distance between this axis Y and the edge 34a of each block 32a, 32b is noted D1 and is for example between 10 and 100 mm, preferably between 20 and 50 mm, and more preferably between 20 and 30 mm (FIG. 7c).

The second part 36 of each block 32a, 32b is shaped to match the shape of the arm 16 and therefore of the pressure side face 16a or suction side face 16b of the arm 16. The block 32a located on the side of the pressure side face 16a therefore has a convex curved shape complementary to the concave curved shape of this face 16a. The block 32b located on the side of the suction side face 16b therefore has a concave curved shape complementary to the convex curved shape of this face 16b.

The second part 36 of each block 32a, 32b comprises a free longitudinal edge 36a which is configured to extend along the aforementioned line L3 or L4. Each edge 36a is a tracing edge.

The distance between the edge 36a of each block 32a, 32b and the shroud 12, 14 is noted D2 and is for example between 10 and 100 mm, preferably between 20 and 50 mm, and more preferably between 20 and 30 mm.

Each of the blocks 32a, 32b may be generally L-shaped in that the second portion 36a may extend substantially perpendicular to the first part 34a.

FIG. 8 shows that each of the blocks 32a, 32b may comprise projecting pads 40 configured to bear on the casing 10, the remainder of each of the blocks being configured to be set back relative to the casing to define a mounting clearance J for the or each control device 32. This mounting clearance allows to compensate for any variations in the dimensions of the casing 10 due to manufacturing tolerances.

In the example shown, the first part 34 of each block 32a, 32b comprises a pad 40 which extends along the edge 34a, over substantially its entire length. The second part 36 of each block 32a, 32b comprises a pad 42 which extends along the edge 36a, over substantially its entire length.

FIGS. 4 to 6 also show that each of the blocks 32a, 32b comprises at least one portion 44a configured to be applied against a complementary portion 44b of the other of the blocks, so as to allow the two blocks to be attached or held together. The portions 44a, 44b may be attached together or held together by attachment or clamping systems such as screw and nut systems. Alternatively, magnets could be attached to or integrated into the portions 44a, 44b, which would then be held together by the cooperation of these magnets.

Alternatively, the blocks 32a, 32b could be held together and in position solely by hand by the operator.

The control devices 32 in FIG. 4 are all different in the example shown. They differ from each other in that they are mounted on arms 16 of different shapes and on different ends of these arms. Two control devices (both on the right of the drawing) are configured to be mounted around inner ends 16a of the arms 16, and two further control devices (both on the left of the drawing) are configured to be mounted around outer ends 16b of the arms 16.

To make it easier for an operator to distinguish between devices 32 when handling and using them, it would be possible to provide different colors between the devices or even for the blocks 32a, 32b of the same device.

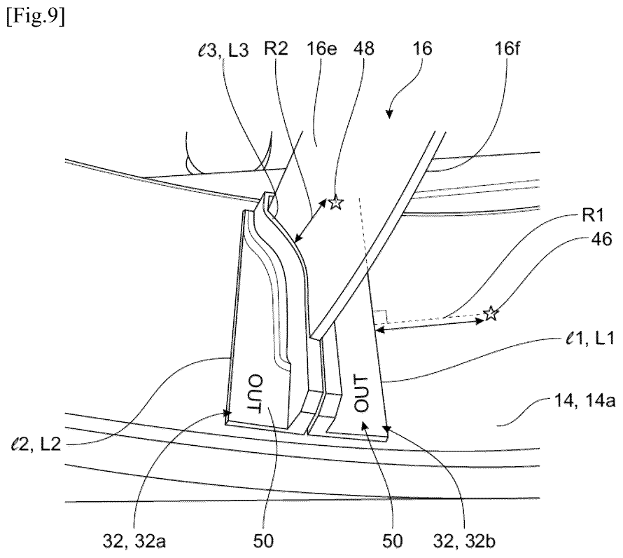

In addition, each of the blocks 32a, 32b may comprise an indication 50 for mounting on the inner or outer end of the arm 16, as shown in FIG. 9. This indication 50 may be integrated into each block 32a, 32b and may, for example, be a projecting or recessed wording, such as “out” and “in”, with reference to the mounting on the outer end 16b (“out”) or on the inner end 16a (“in”) of the arm 16.

Each of the blocks 32a, 32b is formed in one-part in the example shown and is preferably produced by additive manufacturing. For example, they are made of thermoplastic polyurethane.

We will now describe the method according to the invention for locating a mark on the casing 10.

The method comprises a step a) of visually inspecting the arms 16, the outer surface 12a of the internal shroud 12 and the inner surface 14a of the external shroud 14.

Markings 46, 48 are schematically represented by stars in FIG. 9. A mark 46 is located on the surface 14a of the shroud 14 and another mark 48 is located on the pressure side face 16e of the arm 16.

In the event that at least one mark 46, 48 is detected in step a) of the method, the method comprises:
b) a step of manually mounting a visual control device 32 around the inner end 16a or outer end 16b of one or more of the arms 16, and
c) a step of determining the location of the or each mark 46, 48 in one of the aforementioned areas Z1, Z2, Z3 of the casing 10.

When a mark is hidden by the device 32 when it is present on the casing 10, it is understood that this mark is located in an area Z1 of the casing 10.

When a mark is located on the surface 12a, 14a of the shroud 12, 14 and is not hidden by the control device 32 in step b), it is understood that this mark is located in an area Z2.

When a mark is located on the arm 16 and is not hidden by the control device 32 in step b), it is understood that this mark is located in an area Z3.

Advantageously, to make it easier to locate the marks 46, 48, the method may comprise, between steps b) and c):
i) a first intermediate step wherein at least one line [symbol] 1, [symbol] 2, [symbol] 3, etc. is drawn, for example with a felt-tip pen, on the arm 16 and/or the outer surface 12a of the internal shroud 12 and/or the inner surface 14a of the external shroud 14, along the edges L1, L2, L3, L4 of the or each control device 32, as illustrated in FIG. 9, and
ii) a second intermediate step wherein the or each control device 32 is removed from the casing,
and wherein step c) is carried out in dependence on the position of the or each mark 46, 48 relative to the or each drawn line [symbol] 1, [symbol] 2, [symbol] 3, etc.

In the example embodiment shown in FIG. 9, it may be seen that the marks 46, 48 are not located in the area Z1, in particular because it is not hidden by the devices 32 and is not found between the lines [symbol] 1, [symbol] 2, [symbol] 3, etc. after removal of the devices 32. The mark 46 is located on the surface 14a of the shroud 14 and therefore in the area Z2. The distance R1 between the mark 46 and the line [symbol] 1 can be accurately measured by an operator using a ruler or square, preferably in a direction perpendicular to the line [symbol] 1. The mark 48 is located on the pressure side face 16e of the arm and therefore in the area Z3 as it is not hidden by the devices 32 and is located on the arm 16. The distance R2 between the mark 46 and the line [symbol] 3 can be precisely measured by the operator using the ruler or the square, preferably in a direction perpendicular to the line [symbol] .

In the event that the control device 32 of FIG. 4 is used, it is understood that, in step b), a first control device 32 is mounted around an inner end 16a of a first arm 16, and a second control device 32 is mounted around an inner end 16a of an adjacent second arm 16, as illustrated in FIGS. 6 and 7a-7c. It is also understood that in the same step, a third control device 32 is mounted around an outer end 16b of the first arm 16, and a fourth control device 32 is mounted around an outer end 16b of the adjacent second arm 16, as shown in FIG. 5.

The tooling 30 and the method according to the invention allow in particular:
to simplify the control by the operators, who will no longer have to worry about how to take the measurements; in fact, with the tooling 30, the operator may draw lines and measure the positions of the marks 46, 48 in relation to these lines;
to guarantee that the control requested will be compliant and identical for all operators;
to avoid mistakes;
to make the requested control more visual, etc.

1. A method for locating a mark on the casing of an aircraft turbomachine, this casing comprising two coaxial annular shrouds, an internal shroud and an external shroud respectively, and arms which extend between the shrouds and which each comprise an inner end connected to an outer annular surface of the internal shroud and an outer end connected to an inner annular surface of the external shroud, wherein the method comprises:
a) a step of visually inspecting the arms, the outer annular surface of the internal shroud, and the inner annular surface of the external shroud, and
if at least one mark is detected in step a),
b) a step of manually mounting a visual control device around the inner or outer end of one or more of the arms on which said at least one mark is detected, the or each control device being configured to cover part of the inner end of an arm and part of the outer annular surface of the internal shroud extending around that inner end, or to cover part of the outer end of the arm and part of the inner annular surface of the external shroud extending around that outer end, and
c) a step of determining the location of said at least one mark in an area of the casing:
said at least one mark being located in a first area of the casing, which is an area of junction of one of the arms with one of the shrouds, when said at least one mark is hidden by the control device in step b),
said at least one mark being located in a second area of the casing, which is an area of an arm excluded from the junction areas of this arm, when said at least one mark is located on the annular surface of the shroud and is not hidden by the control device in step b), and
said at least one mark being located in a third area of the casing, which is an area of the casing excluded from the junction areas of the arms, when said at least one mark is located on the arm and is not hidden by the control device in step b).

2. The method as claimed in claim 1, wherein it comprises, between steps b) and c):
i) a first intermediate step wherein at least one line, is drawn on the arm and/or the outer annular surface of the internal shroud and/or the inner annular surface of the external shroud, along edges of the or each control device, and
ii) a second intermediate step wherein the or each control device is removed from the casing,
and wherein step c) is carried out as a function of the position of said at least one mark relative to the or each line drawn.

3. The method according to claim 2, wherein said at least one line is drawn with a felt-tip pen.

4. The method according to claim 1, wherein, in step b):
a first control device is mounted around an inner end of a first arm on which said at least one mark is detected, and a second control device is mounted around an inner end of an adjacent second arm on which said at least one mark is detected.

5. The method according to claim 4, wherein, in step b):
a third control device is mounted around an outer end of the first arm on which said at least one mark is detected, and a fourth control device is mounted around an outer end of the adjacent second arm on which said at least one mark is detected.

6. The method according to claim 1, wherein, the or each control device comprising two blocks, step b) comprises positioning the two blocks on either side of the arm.

7. The method according to claim 6, wherein the two blocks are attached or held together.

8. A tooling for implementing a method according to claim 1, the tooling comprising at least one visual control device configured to be mounted around an outer or inner end of an arm of the casing, the or each control device comprising two blocks configured to be mounted on either side of the arm, each of these blocks comprising:
a first part configured to cover part of the inner annular surface of the external shroud or the outer annular surface of the internal shroud,
a second part configured to cover part of a pressure side or suction side face of the arm, and
a junction between the first and second parts configured to extend at the level of a connection fillet connecting the face part with the annular surface part.

9. The tooling of claim 8, wherein each of the blocks is generally L-shaped.

10. The tooling according to claim 8, wherein each of the blocks comprises projecting pads configured to bear on the casing, the remainder of each of the blocks being configured to be set back relative to the casing to define a mounting clearance for the or each control device.

11. The tooling according to claim 8, wherein each of the blocks comprises a longitudinal edge configured to form a tracing reference.

12. The tooling according to claim 8, wherein each of the blocks comprises at least one portion configured to be applied against a complementary portion of the other of the blocks, so as to allow the two blocks to be attached or held relative to each other.

13. The tooling according to claim 8, wherein each of the blocks comprises a mounting indication on the inner or outer end of the arm.

14. The tooling according to claim 8, wherein it comprises at least two independent control devices configured to be mounted around inner ends of the arms, and two further independent control devices configured to be mounted around outer ends of the arms.

15. The tooling according to claim 14, wherein the control devices are all different.
